(19) United States
(12) Patent Application Publication
(10) Pub. No.: US 2026/0288164 A1
(43) Pub. Date: Sep. 24, 2026

(54) METHODS FOR COORDINATED CONTROL OF MULTI-UNMANNED VEHICLES BASED ON ENVIRONMENT-ALIGNED LARGE LANGUAGE MODELS

(71) Applicant: TONGJI UNIVERSITY, Shanghai (CN)

(72) Inventors: Bin HE, Shanghai (CN); Bin CHENG, Shanghai (CN); Zhuohui ZHANG, Ningbo (CN); Chenlong LIU, Luoyang (CN); Zhipeng WANG, Shanghai (CN); Yanmin ZHOU, Shanghai (CN); Zhongpan ZHU, Shanghai (CN)

(73) Assignee: TONGJI UNIVERSITY, Shanghai (CN)

(21) Appl. No.: 19/397,822

(22) Filed: Nov. 21, 2025

(30) Foreign Application Priority Data
Mar. 18, 2025 (CN) 202510317496.3

(51) Int. Cl. G05D 1/69; G05D 1/622; G05D 1/644; G05D 1/648; G05D 101/15; G05D 111/30

(52) U.S. Cl. CPC G05D 1/69; G05D 1/622; G05D 1/644; G05D 1/648; G05D 2101/15; G05D 2111/32

(57) ABSTRACT

A method for coordinated control of multiple UVs based on an environment-aligned LLM is provided, including: obtaining, by each of the UVs, a local observation; transmitting, for each of the UVs, the local observation to a prompt system, and obtaining, based on the local observation, a policy prompt and a communication prompt for each of the UVs; executing a centralized training phase, including: obtaining a global state; generating, for each of the UVs, an executable action sequence and an action execution probability of each action in the executable action sequence; obtaining, for each of the UVs, a next action, executing the next action, and obtaining a reward value; and inputting the global state and the reward value into a critic network, and optimizing parameters of a policy network; executing a distributed execution phase, including: for each of the UVs, obtaining an action probability distribution function; and obtaining the next action.

### CROSS-REFERENCE TO RELATED APPLICATIONS

This application claims priority to the Chinese Patent Application No. 202510317496.3, filed on Mar. 18, 2025, the contents of which are hereby incorporated by reference.

### TECHNICAL FIELD

The present disclosure generally relates to the field of coordinated control of unmanned vehicles (UVs), and in particular to a method for coordinated control of multiple UVs based on an environment-aligned large language model (LLM).

### BACKGROUND

Currently, coordinated control of UVs primarily employs reinforcement learning (RL), multi-agent reinforcement learning (MARL), game theory manners, and rule-based decision systems. Manners based on the RL exhibit strong adaptive capabilities in high-dimensional decision-making problems, but limitations still remain, such as limited information sharing among the multiple UVs, slow training convergence, and low coordination efficiency.

In existing technologies, there have been proposals regarding utilizing large language models for training UVs. For example, Chinese Patent Application No. CN118761453A discloses a reinforcement-learning method for autonomous driving safety based on LLM and knowledge graph (KG) constraints. The method includes: obtaining environmental information at an initial time step; generating question prompts through a constraint-reward question-answerer (QA) module constructed using a large language model and a knowledge graph, thereby generating real-time constraint text; delivering the constraint text together with state information to an UV for the UV to take an action; obtaining a new state, a prompt question, and constraint text at a time step t+1, and evaluating the action taken at the previous time step using the constraint-reward QA module to provide a reward; inputting the constraint text, state information, and a comprehensive reward into the UV so that the UV takes an action at that time step; and performing iterative safety learning until the strategy converges. The limitation of this method lies in constraining only a decision-making process of a single UV, while neglecting generation of global states and coordination of actions in coordinated operations of multiple UVs. The method fails to fully consider information sharing, global state construction, and collaborative decision-making issues in a multi-UV system. This method primarily constrains a single UV through a constraint-reward QA module. In the multi-UV system, optimization of individual rewards does not necessarily lead to an optimum of the multi-UV system and may even cause degradation in overall collaborative performance due to inconsistent individual objectives.

Therefore, it is desirable to provide a method for coordinated control of multiple unmanned vehicles (UVs) based on an environment-aligned large language model, which can fully consider the information sharing, the global state construction, and the collaborative decision-making problems in multi-unmanned vehicle systems, thereby improving the overall collaborative performance.

### SUMMARY

One or more embodiments of the present disclosure provide a method for coordinated control of multiple unmanned vehicles (UVs) based on an environment-aligned large language model, including: obtaining, by each of the UVs, a local observation from an environment; transmitting, by each of the UVs, the local observation to a prompt system, and obtaining, based on the local observation, a policy prompt and a communication prompt for each of the UVs via the prompt system; executing a centralized training phase, including: obtaining, based on the communication prompt, a global state via a communication network; generating, by each of the UVs, an executable action sequence and an action execution probability of each executable action in the executable action sequence based on the policy prompt via a policy network; obtaining, by each of the UVs, a next action through sampling based on the action execution probability, executing the next action and obtaining a reward value; and inputting the global state and the reward value into a critic network, and optimizing parameters of the policy network shared by all of the UVs via the critic network; executing a distributed execution phase, including: obtaining, by each of the UVs, an action probability distribution function via the optimized policy network based on the policy prompt; and obtaining, by each of the UVs, the next action through sampling based on the action probability distribution function.

Compared with the existing technologies, the present disclosure at least includes the following beneficial effects:

(1) The present disclosure implements completion of the global state through the large language model, reducing dependence of the system on accessing the global state. For multi-agent reinforcement learning (MARL), using the environment-aligned large language model aggregates the local observation obtained by each UV into the global state of the system, allowing the UVs to obtain global information in environments where the global state is inaccessible, and utilizing the global state to assist in evaluating the policy network, thereby reducing the dependence of the system on accessing the global state.

(2) The present disclosure leverages the complementary strengths of MARL and LLMs. This synergy addresses two key issues: the environmental misalignment inherent in LLMs, and the reliance on the global state by the Centralized Training with Decentralized Execution (CTDE) paradigm in MARL. The environment-aligned LLM can be pre-trained using an offline dataset. Through instruction prompting, the communication model is fine-tuned on the offline dataset, maintaining sufficient generalization capability when deployed during the online training process.

(3) The present disclosure guides the LLM to generate the global state and the actions through the prompt system, achieving information sharing among individual UVs, enabling each UV to make optimal decisions based on the global information, avoiding decision conflicts, path overlaps, etc., caused by limited local observations in traditional manners, and improving the coordinated control capability of the multiple UVs.

(4) The present disclosure infers the global state through the communication network, utilizing the environment-aligned LLM combined with local observation data of the UVs to infer the global state at a current time step, and provides the global state as input to each UV, enabling policy optimization based on the global information. Compared to existing technologies that rely solely on constraint texts from knowledge graphs, this method enhances the adaptability of the multiple UVs to complex and dynamic environments.

(5) The present disclosure optimizes policy generation through the LLM and the policy prompt, thereby improving decision quality. The present disclosure employs the LLM to interpret task requirements and generates actions through the policy prompt, enabling the UVs to not only rely on action probabilities calculated by traditional reinforcement learning manners during decision-making but also by incorporating textual task instructions. Compared to the technical solutions in existing technologies that rely solely on reinforcement learning for action decisions, the method of the present disclosure can generate control strategies that better align with task objectives in complex environments.

(6) The present disclosure enables all UVs to share a set of parameters of the policy network and updates the policy through collective trajectory data. The present disclosure collects trajectory data of all UVs during training, including the global state, the local observations, the executed actions, the reward values, etc., and uses these data to optimize the shared policy network, enabling each UV to maintain consistent decision-making when facing different environments. Compared to the technical solutions in existing technologies that only optimize the policy of a single UV, the present disclosure significantly improves the coordinated consistency and the decision generalization capability of the UV cluster.

### BRIEF DESCRIPTION OF THE DRAWINGS

The present disclosure is further described by way of exemplary embodiments. These exemplary embodiments are described in detail with reference to accompanying drawings. These embodiments are non-limiting. In these embodiments, the same reference numerals denote same structures.

FIG. 1 is a flowchart illustrating an exemplary process of a method for coordinated control of multiple UVs based on an environment-aligned LLM according to some embodiments of the present disclosure.

FIG. 2 is a schematic diagram illustrating an exemplary process for coordinated control of multiple UVs according to some embodiments of the present disclosure.

FIG. 3 is an exemplary system relationship diagram illustrating an environment-aligned large language model module and multi-agent reinforcement learning (MARL) according to some embodiments of the present disclosure.

FIGS. 4(a) and 4(b) are flowcharts illustrating implementation examples of a method for coordinated control of multiple UVs based on an environment-aligned LLM according to some embodiments of the present disclosure, wherein FIG. 4(a) is a flowchart for a dual-motor vision-based intelligent vehicle cluster performing an environmental exploration task with access to a global state, and FIG. 4(b) is a flowchart for a dual-motor vision-based intelligent vehicle cluster performing an environmental exploration task without access to a global state.

### DETAILED DESCRIPTION

Technical solutions in the embodiments of the present disclosure are clearly and completely described below with reference to accompanying drawings in the embodiments of the present disclosure. Obviously, the described embodiments are only a part of the embodiments of the present disclosure, rather than all embodiments. All other embodiments obtained by those of ordinary skill in the art based on the embodiments of the present disclosure without creative efforts shall fall within the protection scope of the present disclosure.

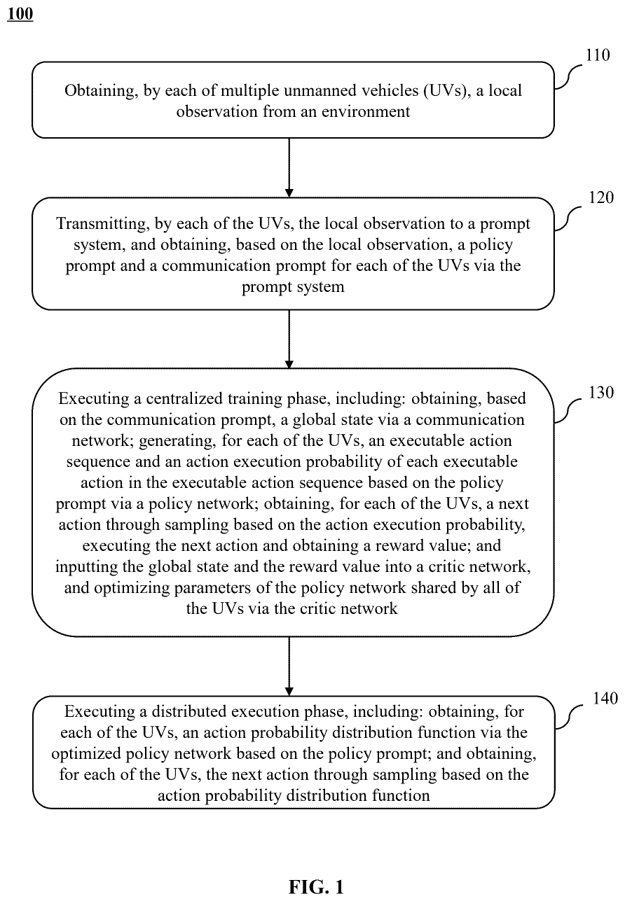

FIG. 1 is a flowchart illustrating an exemplary process of a method for coordinated control of multiple UVs based on an environment-aligned LLM according to some embodiments of the present disclosure.

The method for coordinated control of multiple UVs based on the environment-aligned LLM (also referred to as the multi-UV control method or the method) provided in some embodiments of the present disclosure may be executed on a computing device. The computing device includes at least one processor, at least one non-transitory computer-readable storage medium, and a communication port connected to the at least one processor and the at least one non-transitory computer-readable storage medium.

In some embodiments, the processor may include a central processing unit (CPU), an application-specific integrated circuit (ASIC), an application-specific instruction set processor (ASIP), a physics processing unit (PPU), a digital signal processor (DSP), a graphics processing unit (GPU), a microcontroller unit, a reduced instruction set computer (RISC), a microprocessor, or any combination thereof. In some embodiments, the processor may be local or remote. In some embodiments, the processor may be implemented on a cloud platform. Merely by way of example, the cloud platform may include a private cloud, a public cloud, a hybrid cloud, a community cloud, a distributed cloud, an internal cloud, a multi-layer cloud, or any combination thereof.

In some embodiments, the multi-UV control method is implemented by the processor using an environment-aligned large language model (LLM).

In some embodiments, the environment-aligned large language model includes a policy network based on the environment-aligned large language model, a communication network based on the environment-aligned large language model, a prompt system, and a critic network based on a multilayer perceptron. The policy network and the communication network are both pre-trained LLMs.

The policy network refers to a module configured to output an executable action sequence and an action execution probability for a UV.

In some embodiments, the policy network may be a pre-trained LLM.

The executable action sequence refers to a sequence of a plurality of actions that the UV is allowed to execute under a current local observation, a dynamic constraint, and a traffic regulation. For example, the executable action sequence may include one or more of forward, backward, left turn, right turn, stop, accelerate, and decelerate.

The action execution probability refers to a probability that an action in the action sequence of the UV is executed.

An LLM refers to a deep learning network based on a decoder architecture. Examples of pre-trained LLMs may include, but are not limited to, GPT, DeepSeek, etc.

The communication network refers to a module configured to obtain a global state. The global state refers to states of all the multiple UVs and a state of an environment in which all the UVs are located.

In some embodiments, the communication network may be a pre-trained LLM.

The prompt system refers to a system used to obtain a policy prompt and communication information.

The multilayer perceptron refers to a module formed by sequentially connecting at least three layers of feed-forward fully-connected networks (FCNNs).

The critic network refers to a module configured to optimize parameters of the policy network.

In some embodiments, at least one multilayer perceptron is connected to form the critic network.

In some embodiments of the present disclosure, the policy network, the communication network, the prompt system, and the critic network based on the multilayer perceptron are adopted, enabling a one-time loading during the offline phase. This approach significantly reduces the count of system models and storage overhead, lowers the difficulty of distributed deployment, and maps numerical observations into natural language without the need to redesign feature engineering. It endows the policy and communication modules with the ability to adapt instantly to unknown scenarios, realizing a hybrid architecture of “large model generation+small model evaluation,” thereby balancing both precision and computational efficiency.

In some embodiments, as shown in FIG. 1, a process 100 may be executed by the processor. The process 100 may include operations 110 to 140.

In 110, obtaining, by each of the UVs, a local observation from an environment.

A UV is an automated mobile platform with independent perception, decision-making, and execution capabilities.

For example, the UV may include a wheeled mobile robot, a legged/tracked robot, an unmanned aerial vehicle, an unmanned surface/underwater vehicle, an autonomous vehicle, etc.

The environment refers to a physical space in which the UV operates. For example, the environment may include an indoor structured scene, an outdoor unstructured area, an airspace, a water environment, etc.

The local observation of a UV is a partial set of information perceived by the UV from the environment at a current time step. The local observation may include position information, velocity information, path planning information, sensor information, and environmental state information of the UV.

The path planning information of a UV refers to information related to a path when the UV executes a task. For example, the path planning information may include a travel path, a travel speed, etc., of the UV.

The sensor information of a UV refers to environmental data detected by a sensor (e.g., a LiDAR sensor, a camera, etc.) of the UV. For example, the sensor information may include obstacle distribution, lane line information, a traffic light state, etc.

The environmental state information refers to information related to a physical environment in which the UV is located. For example, the environmental state information may include temperature, wind speed, light intensity, etc.

In some embodiments, each of the UVs may obtain the local observation in various ways.

For example, each of the UVs may monitor changes in obstacles around the UV via a LiDAR sensor loaded on the UV, and determine the position information, the velocity information, the path planning information, etc., of the UV.

As another example, each of the UVs may obtain the environmental state information via a sensor (e.g., a temperature sensor, a humidity sensor) loaded on the UV.

In 120, transmitting, by each of the UVs, the local observation to a prompt system, and obtaining, based on the local observation, a policy prompt and a communication prompt for each of the UVs via the prompt system.

It is understood that the prompt system constructs the policy prompt and the communication prompt, enabling the policy network and the communication network to more effectively interpret an operation task and environmental information of the UV, thereby ensuring reasonableness of policy generation.

In some embodiments, the processor may control each of the UVs to send the local observation to the prompt system via a network.

The policy prompt refers to structured text for guiding the policy network to generate an executable action.

In some embodiments, the policy prompt includes a policy instruction part, a policy input part, and a policy response part.

The policy instruction part is used to describe a task objective and specify a decision-making purpose of each of the UVs. The policy instruction part includes navigation, obstacle avoidance, and collaborative task execution. In some embodiments, the processor may extract a textual description corresponding to a current task instruction of each of the UVs from a preset task library based on the current task instruction of each of the UVs.

A task instruction for a UV refers to an instruction describing an operation task that the UV needs to complete.

The task library refers to a database storing tasks of the UVs.

In some embodiments, the task library may include a relationship between task instructions and textual descriptions corresponding to the task instructions. The task library may be preset by a technician based on experience.

In some embodiments, the processor may determine the textual description corresponding to the task instruction as the policy instruction part.

The policy input part is textualized local observations of all of the UVs.

For example, the policy input part includes states of all of the UVs, perceived environmental information, and key information capable of affecting decisions of other UVs. In some embodiments, the policy input part is described in a form of structured text.

The policy response part is a formatted executable action set.

In some embodiments, the processor may extract all legal actions under current local observation conditions for each of the UVs from a predefined action library and convert the all legal actions into a text form, where the text form of the all legal actions is the policy response part.

The action library refers to a database storing the executable actions of the UVs.

In some embodiments, the action library may include a relationship among local observation conditions, actions, and legality. The action library may be preset by a technician based on experience.

In some embodiments, the executable action set includes forward, backward, left turn, right turn, stop, accelerate, and decelerate.

In some embodiments, the policy instruction further includes role assignment information of each of the UVs.

The role assignment information of a UV refers to annotation information of an internal task role of the UV.

The role assignment information may be used to clarify a functional responsibility undertaken by each of the UVs in a current task phase.

For example, the role assignment information may include reconnaissance, attack, support, path planning, formation guidance, etc.

In some embodiments, the processor may comprehensively determine the role assignment information of each of the UVs based on a type and a count of sensors that are equipped by each of the UVs and operate normally.

For example, an UV equipped with a plurality of high-resolution visual sensors may be preferentially responsible for “image acquisition”; an UV equipped with a plurality of high-performance LiDAR sensors may be preferentially responsible for “obstacle recognition”; an UV equipped with a plurality of wide-angle radars may be preferentially responsible for “path planning”; and an UV equipped with a communication relay module may be preferentially responsible for “relay communication”.

Merely by way of example, if the role assignment information of an UV 1, an UV 2, and an UV 3 is the image acquisition and the obstacle recognition, the policy instruction may be that the UV 1, the UV 2, and the UV 3 collectively perform reconnaissance, perform environmental detection ahead of a path, and preferentially avoid areas with dense obstacles. If the role assignment information of the UV 3 is the path planning, and the role assignment information of the UV 1 and the UV 2 is the image acquisition and the obstacle recognition, the policy instruction may be that the UV 3 is responsible for the path planning, the UV 1 and the UV 2 assist in observation, plan a feasible path to a target area, and balance navigation efficiency and energy consumption.

In some embodiments of the present disclosure, the role assignment information of the UV is embedded into the policy instruction to achieve more refined management of task configuration within a cluster, enabling each of the UVs to possess a clear behavioral objective and a collaborative relationship in a specific phase and improving accuracy of generating the executable action by the subsequent policy network.

The communication prompt refers to structured text for guiding the communication network to infer the global state.

In some embodiments, the communication prompt includes a communication instruction part, a communication input part, and a communication response part.

The communication instruction part is used for describing a communication objective and defining an information interaction goal among the UVs.

For example, the communication instruction part includes sharing environmental information, exchanging state data, and supporting collaborative decision-making.

In some embodiments, the processor extracts a corresponding textual description from a preset communication instruction library based on a preset communication instruction, and designates the textual description as the communication instruction part in the communication prompt.

The communication instruction library refers to a database for storing the communication instruction part.

In some embodiments, the communication instruction library includes a relationship between communication instructions and communication instruction parts. The communication instruction library may be preset by a technician based on experience.

The communication input part is textualized local observations of all of the UVs. For example, the communication input part includes the states of all of the UVs, the perceived environmental information, and the key information capable of affecting decisions of other UVs. In some embodiments, the communication input part is described in the form of structured text.

The communication response part is a textualized global state from a previous time step.

The global state refers to data reflecting states of all of the UVs and a state of the environmental in which all of the UVs are located.

In some embodiments, based on the local observations of all of the UVs at the previous time step, the processor infers the global state through the communication network based on the environment-aligned LLM and converts the global state into a textual representation, where the converted text is the communication response part.

In some embodiments, the prompt system receives the local observation transmitted by each of the UVs, performs formatting processing on the local observation of each of the UVs, converts the local observation of each of the UVs into structured text, and for each of the UVs, combines the structured text for the UV with a preset task instruction to form the policy prompt for the UV.

In some embodiments, the processor combines the structured text of the local observation with the task instruction to form the policy prompt.

It is understood that, via the policy prompt, the processor generates a personalized control strategy for each of the UVs more efficiently, avoiding over-reliance on or neglect of complex environmental information and task requirements in traditional methods. An introduction of the structured text makes the policy network more flexible and possesses stronger reasoning capability when processing complex information, thereby improving the quality and consistency of policy generation. Furthermore, a combination of a predefined action set and the task library further simplifies the decision-making process and improves the decision-making speed and accuracy. Ultimately, construction of the policy prompt not only improves collaborative capability of the multi-UV system in a dynamic environment but also enhances efficiency and reliability of task execution.

In some embodiments of the present disclosure, combining the structured text with the task instruction to form the policy prompt significantly improves decision efficiency, flexibility, collaborative capability, and robustness of the UVs in a complex environment, while simplifying the decision-making process and enhancing the quality and the consistency of the policy generation.

In some embodiments, the prompt system receives the local observation transmitted by each of the UVs, performs the formatting processing on the local observation of each of the UVs, converts the local observation into a textual description, and for each of the UVs, combines the textual description for the UV with a preset communication instruction to generate the communication prompt for the UV.

For example, the prompt system performs numerical normalization on the local observations of the UVs, maps the local observations in to textual form to achieve the formatting processing, and combines the textual descriptions of the formatted local observations with communication instructions to form communication prompts.

In some embodiments of the present disclosure, by converting the local observation of each of the UVs into unified structured text and combining the structured text with the preset communication instruction to generate the communication prompt, efficient information sharing and collaborative decision-making in the multi-UV system are achieved. This process ensures that each of the UVs can timely and accurately exchange environmental information and state data, thereby avoiding the issue of information silos. Meanwhile, by leveraging the reasoning capability of the LLM to generate the global state, the accuracy of decision-making and the efficiency of cooperation are enhanced. Consequently, the collaborative working ability and task execution efficiency of multiple UVs in complex dynamic environments are significantly improved.

In some embodiments, the processor further determines a task phase each of the UVs are located in and surrounding environmental information based on the local observation of each of the UVs; determines the policy instruction and the communication instruction for each of the UVs based on the task phase and the environmental information; generates the policy prompt based on the local observation and the policy instruction; and generates the communication prompt based on the local observation and the communication instruction.

The task phase refers to a progress phase in which the UVs are at while executing a current operation task.

In some embodiments, the task phase includes an initial exploration phase, a path planning phase, a formation cruising phase, a collaborative operation phase, an emergency evasion phase, and a low-battery return phase.

The initial exploration phase refers to a phase where the UVs perform wide-area coverage in an unknown environment to obtain an initial map and the environmental information. The wide-area coverage refers to an operation of scanning and exploring the surrounding environment across a large range.

The path planning phase refers to a phase of planning an optimal or safest path from a current position to a target position for the UVs. The target position refers to a position where the operation task is performed.

The formation cruising phase refers to a phase where the UVs collaboratively advance toward a target area in a formation. The target area refers to a geographical scope where the operation task is located.

The collaborative operation phase refers to a phase where the UVs cooperate in a division of labor near the target position to complete the operation task.

The emergency evasion phase refers to a phase of executing an evasion maneuver to avoid a sudden high-threat target. The high-threat target refers to one or more objects that pose a threat to the safe execution of the operation task by the UVs. For example, the high-threat target includes another vehicle, a person, or an object that rushes rapidly toward the UV and causes damage to the UVs.

The low battery return phase refers to a phase where an UV returns for charging due to insufficient energy.

The environmental information refers to information about an environment of an area where the current task is located.

In some embodiments, the environmental information may include a terrain complexity and a UV density.

The terrain complexity refers to a complexity degree of a shape of the area where the current task is located.

In some embodiments, the terrain complexity is related to an obstacle distribution and a terrain variation of the area where the current task is located. For example, the more numerous, larger, and denser the obstacles in the area, the higher the terrain complexity; similarly, the greater the topographic undulation, the higher the terrain complexity.

The UV density refers to a count of UVs per unit area.

In some embodiments, the processor may determine the count of UVs per unit area based on position information of each of the UVs.

In some embodiments, the processor may determine the task phase and the environmental information of each of the UVs based on the local observation.

For example, if a path for executing the operation task has not been generated, the current task phase is determined to be the “initial exploration phase”. If path information for executing the operation task is complete, the target position of the operation task is clear, and a reachable path exists between the current position and the target position, the current task phase is determined to be the “path planning phase”. If speeds of the UVs are consistent and relative distances between the UVs are stable, the current task phase is determined to be the “formation cruising phase”. If travel trajectories of the UVs show that the current positions of the UVs are all near the target area (e.g., within 10 meters), and endpoints of the path for executing the operation task are concentrated in the same target area, the current task phase is determined to be the “collaborative operation phase”. If a sudden change in speed or a significant change in direction of any UV occurs, the current task phase is determined to be the “emergency avoidance phase”. If a current battery level of any UV is below a preset return threshold (e.g., 30%), and the endpoint of the path for executing the operation task is a return area, the current task phase is determined to be the “low battery return phase”. The return threshold may be preset by a technician based on experience.

As another example, the processor may extract obstacle distribution information and terrain variation information from sensor information in the local observation to determine the terrain complexity; determine the count of UVs per unit area based on position information in the local observation to determine the UV density; and determine the UV density and the terrain complexity as the environmental information.

In some embodiments, the processor may determine the policy instruction and the communication instruction for each of the UVs by querying a first preset table based on the task phase and the environmental information. The first preset table maps different combinations of task phases, terrain complexities, and UV densities to corresponding policy instructions and communication instructions. In some embodiments, the first preset table may be constructed by a technician based on historical data.

Merely by way of example, if the task phase is the initial exploration phase and the environmental information indicates high terrain complexity and sparse UV distribution, the primary task for each of the UVs may be “obstacle avoidance+sharing environmental information.” The processor may query the first preset table to determine the policy instruction as “perform environmental detection ahead of the path, and prioritize avoiding obstacle-dense areas” and the communication instruction as “broadcast obstacle point distribution near the current position to build a shared environmental map.”

As another example, if the task phase is the path planning phase and the environmental information indicates medium terrain complexity and sparse UV distribution, the primary task for each of the UVs may be “navigation+exchanging state data.” The processor may query the first preset table to determine the policy instruction as “plan a feasible path to the target area, balancing navigation efficiency and energy consumption” and the communication instruction as “exchange respective path planning results and compare optimal overlapping segments”.

In some embodiments, the manner of generating the policy prompt based on the local observation and the policy instruction is the same as the manner of generating the policy prompt based on the local observation and the task instruction, which is not repeated herein. More descriptions regarding generating the communication prompt based on the local observation and the communication instruction may be found in the related descriptions of operation 120 above.

In some embodiments of the present disclosure, by setting more relevant and detailed prompt information based on the task phase and the environmental information, dynamic updating of the policy instruction and the communication instruction can be achieved. This approach enables the generation of control strategies that better align with task objectives in complex environments, thereby improving the accuracy of subsequent executable actions generated by the policy network.

In some embodiments of the present disclosure, by constructing the policy prompt and the communication prompt, the prompt system enables the policy network and the communication network to more effectively interpret the task objectives and the environmental information of the UVs, thereby ensuring the rationality of the policy generation. Combined with policy optimization via the critic network based on the multilayer perceptron, this approach reduces reliance on extensive online interaction data, accelerates policy convergence, and simultaneously improves policy stability. Overall, the method improves decision-making quality of the multi-UV system in complex dynamic environments, enabling the UVs to perform collaborative tasks more efficiently, thereby enhancing system reliability and adaptability.

In 130, executing a centralized training phase, including: obtaining, based on the communication prompt, the global state via the communication network; generating, by each of the UVs, the executable action sequence and the action execution probability of each executable action in the executable action sequence based on the policy prompt via the policy network; obtaining, by each of the UVs, a next action through sampling based on the action execution probability, executing the next action and obtaining a reward value; and inputting the global state and the reward value into the critic network, and optimizing the parameters of the policy network shared by all of the UVs via the critic network.

The centralized training phase refers to a phase where the policy network is centrally trained through the critic network.

In some embodiments, the processor, in response to executing the next action and obtaining the reward value, determines that the multi-UV system (also referred to as a multi-UV coordinated control system or a multi-UV collaborative decision-making system) enters the centralized training phase.

For example, when the processor controls the UVs to execute the next action and obtains the reward value after each of the UVs executes the next action, it is considered that the multi-UV coordinated control system is ready to start training the policy network based on the reward value, and thus it is determined that the multi-UV coordinated control system enters the centralized training phase.

In some embodiments, the processor obtains, based on the communication prompt, the global state via the communication network. In some embodiments, the processor may be configured to: process the communication prompt through a tokenizer to obtain a corresponding token sequence; input the token sequence into the communication network; and generate, by the communication network, a textualized global state for the current time step based on the communication objective in the communication prompt, the local observation of each of the UVs, and the textualized global state from the previous time step.

The tokenizer refers to a module configured to process the communication prompt.

In some embodiments, the tokenizer may process the communication prompt into a form of a token sequence.

In some embodiments, the tokenizer may also reversely map the token sequence to natural language text.

The token sequence refers to a data form that may be recognized and received by the communication network.

In some embodiments, the token sequence corresponding to the communication prompt may include the communication objective, the local observations of all of the UVs, and the textualized global state from the previous time step.

For example, the communication prompt before processing by the tokenizer is “UV 1: position (10, 20). Please select: forward, left turn, right turn.” After processing by the tokenizer, the token sequence corresponding to the communication prompt is [1501, 1802, . . . , 8023].

In some embodiments, the processor may input the communication prompt to the tokenizer. The tokenizer performs a tokenization operation, splits coherent text in the communication prompt into a plurality of tokens based on a preset rule, and maps each token to a unique numerical identifier by querying a second preset table. The processor arranges a plurality of numerical identifiers based on the order of their corresponding tokens in the communication prompt, and determines a sequence formed by the arranged numerical identifiers as the token sequence. A token refers to a smallest fundamental unit constituting coherent text. For example, a token may be a word. The preset rule refers to a rule for splitting the coherent text. For example, the preset rule may include performing semantic segmentation on the communication prompt using a semantic model, mapping a same semantic field as a whole to a “semantic subword” in the vocabulary to avoid cross-role segmentation, and using “numerical range subword” mapping to maintain consistency in dimensional semantics.

The textualized global state refers to a natural language description regarding the environment where all of the UVs are located.

For example, the textualized global state may be a natural language description such as “Area A contains obstacles, and the UV cluster is collaboratively approaching the target from an east side.”

The textualized global state from the previous time step refers to a textualized global state from a last historical time step relative to the current time step.

In some embodiments, the processor inputs the token sequence to the communication network. Based on the token sequence, the communication network predicts and outputs a token sequence for the current global state in an autoregressive manner. The token sequence for the current global state is converted back into natural language text by the tokenizer, and the converted natural language text is determined as the textualized global state at the current time step.

For example, the processor may input the token sequence corresponding to the communication prompt into the communication network. Using the token sequence as context, the communication network may sequentially output new tokens one by one. Each newly generated token is appended back to the token sequence, and the communication network continues to predict the next new token until a length limit of the token sequence is reached, thereby forming a new token sequence corresponding to the current global state. The generated new token sequence is converted back into natural language text by the tokenizer. The converted natural language text is determined as the textualized global state at the current time step.

In some embodiments of the present disclosure, inputting the token sequence into the communication network to generate the textualized global state at the current time step enables the communication network to process only a single continuous vector, eliminating multi-modal alignment steps and reducing interface complexity. By leveraging pre-trained causal semantics, occlusions can be completed and the dynamics of occluded regions can be inferred in a single step, resulting in higher output accuracy compared to traditional fusion algorithms. Since the textualized global state is entirely generated from the local observation of each vehicle, the system does not require externally deployed fixed sensors or a central server, significantly reducing deployment costs and making the system suitable for scenarios such as sudden disasters and temporary control situations.

In some embodiments, the processor may use the policy network to convert the policy prompt into the executable action sequence and the action execution probability.

For example, the policy network may receive the policy prompt in the form of a token sequence, use the token sequence as context, and sequentially output new tokens one by one. Each newly generated token is appended back to the token sequence, and the policy network continues predicting the next new token until a length limit of the token sequence is reached, thereby forming a token sequence of candidate actions. An initial generation probability for each token in the token sequence of candidate actions may be determined, the initial generation probabilities for the tokens are then calibrated and normalized, and processed probability values of all candidate actions are mapped to a standard probability distribution. The standard probability distribution is determined as the action execution probability of each executable action in the executable action sequence.

In some embodiments, the processor may process the policy prompt through the tokenizer to generate a policy prompt token sequence, and provide the policy prompt token sequence as an input to the policy network based on the environment-aligned LLM. The policy network, based on the policy prompt token sequence, generates an executable action token sequence and a generation probability corresponding to the executable action token sequence, using an equation:

$$P ( {a}_{i} \vert o ) = \frac{{\prod }_{i = 1}^{{T}_{{a}_{i}}} P ( {x}_{i} \vert {x}_{1} , {x}_{2} , … , {x}_{i - 1} )}{{\prod }_{j = 1}^{{T}_{o}} P ( {x}_{j} \vert {x}_{1} , {x}_{2} , … , {x}_{j - 1} )}$$

wherein P(aᵢ|o) represents a generation probability of generating an action sequence aᵢ given the local observations o of all of the UVs, Tₐ_{ᵢ} denotes a token count of the action sequence aᵢ, Tₒ denotes a token count of a local observation sequence o of all of the UVs, and P(xᵢ|x₁, x₂, . . . , xᵢ₋₁) represents a probability of generating a current token xᵢ given preceding i−1 tokens; and an executable action includes one or more tokens. Softmax normalization processing may be performed on the executable action token sequence to obtain the action execution probability of each executable action in the executable action sequence, using an equation:

$${P}_{softmax} ( {a}_{i} \vert o ) = \frac{exp ( log P ( {a}_{i} \vert o ) / \vert {a}_{i} \vert )}{{\sum }_{{a}_{i} ∈ A} exp ( log P ( {a}_{i} \vert o ) / \vert {a}_{i} \vert )}$$

wherein P_{softmax}(aᵢ|o) denotes an action execution probability of an action aᵢ given a local observations o of all of the UVs, |aᵢ| denotes a count of tokens in the executable action aᵢ, and A denotes an executable action set containing all executable actions.

The generation probability refers to a probability for generating the action sequence under the condition that the local observations of all UVs are given.

The policy prompt token sequence refers to a sequence composed of integer indices (i.e., tokens) that can be interpreted by the LLM.

For example, after processing a structured policy prompt text by the tokenizer, the obtained policy prompt token sequence may be (the following are illustrative token IDs): [101, 2345, . . . , 3088, 102].

In some embodiments, the processor may input the policy prompt into the tokenizer. The tokenizer converts each word in the policy prompt into a corresponding token according to a vocabulary of the tokenizer, and all of the tokens are arranged in the order of the original words. The arranged token sequence is determined as the policy prompt token sequence. The vocabulary refers to a data table including relationships between words and tokens. In some embodiments, the vocabulary may be preset by the processor by default.

In some embodiments, by inputting the policy prompt into the tokenizer, the processor can simultaneously obtain the policy prompt token sequence and the token sequence.

The action token sequence refers to a token sequence representing one or more specific control instructions.

In some embodiments, the action token sequence, after decoding, may be directly mapped to executable actions for the UV.

For example, based on a policy prompt token sequence [101, 2345, . . . , 3088, 102], the policy network may generate an action token sequence such as: [4501, 1, 11, 2050, 6, 2, 11, 2052, 102].

In some embodiments, the policy network may generate the executable action token sequence and the corresponding generation probability in a plurality of ways.

For example, the policy network may use the policy prompt token sequence as a prefix and perform autoregressive token-by-token prediction of logits. For each candidate action, the prediction continues until an end-of-sequence token is encountered, thereby obtaining a complete token sequence of the action and logits of each of the tokens for the action. The logits are averaged and then normalized through a softmax operation to obtain the action execution probability of the action.

It should be noted that each action may consist of a different count of tokens (e.g., “stop” and “move north one step” have one token and four tokens, respectively). When the action execution probability is computed as a product of token probabilities, actions containing more tokens result in smaller cumulative values. To address this issue, the action execution probability is divided by a token length to ensure that action execution probabilities of actions with different token lengths are on a same scale. Furthermore, the computed probability P(aᵢ|o) is essentially the logits for each token and is not normalized. Therefore, an additional softmax operation is applied to the logits to obtain the action execution probability for each executable action.

In some embodiments of the present disclosure, by performing length normalization and softmax normalization on the LLM-generated action execution probabilities for the executable actions, probability bias problem in a textual action space is solved, thereby obtaining a fair, comparable, and sampling-ready action probability distribution and ensuring fairness, effectiveness, and exploratory of the decision-making process for the multiple UVs.

The next action refers to a uniquely executable action selected at the current time step.

For example, if the local observation at the current time step includes the following: coordinates of the UV relative to a center point of the operation task are (10, 2), a driving direction of the UV is 0°, and a speed of the UV is 2 m/s; a stationary obstacle (e.g., a truck having a length of 4 m) is located 5 m ahead of the UV and occupies a center of a lane; a traffic light at the current time step is green with a remaining time of 25 s, a task instruction at the current time step is to change lanes to a right-adjacent lane; a set of legal actions at a next time step includes KEEP (maintain a current lane and a current speed), ACCEL (accelerate by 1 m/s in a same lane), TURN RIGHT (change lanes to a right lane, with a lateral displacement of 0.5 m and synchronously adjusting the driving direction), DECEL (decelerate by 1 m/s in the same lane), and STOP (emergency brake to a zero speed). If the action probability distribution output by the policy network is sampled to obtain TURN RIGHT, then TURN RIGHT is the uniquely executable action (i.e., the next action) at the next time step.

In some embodiments, the processor may randomly select an action from a set of actions (i.e., the policy response part in the policy prompt) as the next action under the condition that the policy prompt is given.

In some embodiments, the processor may further select, based on the action execution probability generated for each of the UVs, an action from the executable action set using a stochastic sampling technique. The stochastic sampling technique includes: performing a weighted random selection based on the action execution probability of each action in the executable action set, designating the action execution probability of each action in the executable action set as a weight of selection for the each action, and randomly selecting an action from the executable action set.

In some embodiments of the present disclosure, by performing sampling based on the action execution probability generated for each of the UVs, a most suitable action can be dynamically selected during the collaboration of the multiple UVs. This process utilizes the stochastic sampling technique to perform the weighted random selection from the set of executable actions based on the execution probability of each action. The execution probability of each action serves as the weight of selection for the each action, meaning that an action with a high execution probability has a greater likelihood of being selected, while an action with a low execution probability has a smaller likelihood of being selected. In this way, the system can flexibly make reasonable decisions according to the current state (e.g., including the global state, the task phase, the environmental information, etc.) and task requirements.

In some embodiments of the present disclosure, by introducing the stochastic sampling technique, exploration and adaptability of the system are enhanced, thereby avoiding the decision-making from being overly rigid or confined to a fixed strategy, and enabling rapid adjustment and optimization of UV behaviors under different environmental changes and task demands. Simultaneously, performing sampling based on the execution probability enables a balance between exploration and exploitation, ensuring that, on the basis of high-probability actions, sufficient room remains for trying new strategies, thereby improving robustness and self-adaptive capability of the multi-UV collaborative decision-making system in complex and dynamic environments.

In some embodiments, the processor may send the next action to each of the UVs via the communication network for execution.

The reward value of a UV refers to a parameter used to evaluate a contribution degree of the UV to the operation task after executing the action.

In some embodiments, the higher the reward value is, the greater the contribution degree of the UV to the operation task after executing the action.

In some embodiments, the processor may determine the reward value based on a task progress and energy consumption data. The task progress refers to a completion progress of the operation task after the UV executes the next action. The energy consumption data refers to data reflecting energy consumed by the UV after executing the next action.

In some embodiments, the processor may designate a difference in the completion progresses of the operation task performed by a UV before and after executing the next action, as determined based on data obtained from a sensor such as a radar and a camera equipped on the UV, as the task progress of the UV.

In some embodiments, the processor may designate an average energy consumption of a UV before and after executing the next action as the energy consumption data of the UV.

In some embodiments, the processor may perform a plurality of rounds of iteration on the policy network based on the global state at the current time step and the reward value until the count of iterations reaches a threshold, thereby obtaining an optimized policy network.

In some embodiments, the processor may further input the global state at the current time step and the corresponding reward value into the critic network. The critic network determines a state-value function based on the global state at the current time step, using an equation:

$${V}_{π} ( {S}_{t} ) = E [ {\sum }_{t = 0}^{∞} {γ}^{t} {r}_{t + 1} \vert {s}_{0} = {S}_{t} ]$$

wherein γ denotes a discount factor, π represents a joint policy,

$$π = {\prod }_{i = 1}^{n} {π}^{i} ,$$

πⁱ denotes a policy of a UV i, s₀ denotes a global state at an initial time step, V_{π}(Sₜ) represents an expected cumulative reward obtainable from the global state Sₜ under a policy π obtained from a current policy network, and t represents a time step.

The critic network determines an action-value function Q_{π}(Sₜ, aₜ) based on the global state and an action aₜ executed at the current time step, using an equation:

$${Q}_{π} ( {S}_{t} , {a}_{t} ) = 𝔼 [ {\sum }_{t = 0}^{∞} {γ}^{t} {r}_{t + 1} \vert {s}_{0} = {S}_{t} , {a}_{0} = {a}_{t} ]$$

wherein a₀ denotes an action taken at the initial time step, and Q_{π}(Sₜ, aₜ) represents an expected cumulative reward obtainable after taking the action aₜ in the global state Sₜ under the policy π obtained from the current policy network.

Based on the state-value function V_{π}(Sₜ) and the action-value function Q_{π}(Sₜ, aₜ), the processor may determine an advantage function A_{π}(Sₜ, aₜ), using an equation:

$${A}_{π} ( {S}_{t} , {a}_{t} ) = {Q}_{π} ( {S}_{t} , {a}_{t} ) - {V}_{π} ( {S}_{t} )$$

wherein A_{π}(Sₜ, aₜ) represents a measure of an advantageous degree of taking the action aₜ in the global state Sₜ, relative to an average performance of the policy π.

based on the advantage function A_{π}(Sₜ, aₜ), the processor may determine a policy optimization objective function J(θ), using an equation:

$$J ( θ ) = {\sum }_{i = 1}^{n} {E}_{s , a} [ min ( \frac{{π}_{θ} ( {a}^{i} \vert {o}^{i} )}{{π}_{{θ}_{k}} ( {a}^{i} \vert {o}^{i} )} {A}_{{π}_{{θ}_{k}}} ( s , a ) , clip ( \frac{{π}_{θ} ( {a}^{i} \vert {0}^{i} )}{{π}_{{θ}_{k}} ( {a}^{i} \vert {0}^{i} )} , 1 \pm ϵ ) {A}_{{π}_{{θ}_{k}}} ( s , a ) ) ]$$

wherein π_{θ}(aⁱ|oⁱ) represents an action probability of the current policy network, π_{θ}_{ₖ}(aⁱ|oⁱ) represents a policy from a previous iteration step, a ratio of π_{θ}(aⁱ|oⁱ) to π_{θ}_{ₖ}(aⁱ|oⁱ) represents an importance sampling ratio measuring a change in action selection between a new policy and an old policy,

$${A}_{{π}_{{θ}_{k}}}$$

(s, a) represents an advantage function of the policy from the previous iteration step, a clip operation constrains the importance sampling ratio within a range [1−ϵ, 1+ϵ], ϵ denotes a hyperparameter defining a maximum change range for a policy update. The policy optimization objective function J(θ) is optimized via gradient descent to adjust the parameters of the policy network.

The state-value function is used to measure an expected cumulative discounted reward of following the policy from a given global state.

The action-value function is used to measure an expected cumulative discounted reward of executing an action in a given global state and then following the policy from the given global state.

The advantage function is used to represent a measure of an advantageous degree of an action relative to the average performance from the global state.

The policy optimization objective function is used to ensure training stability.

In some embodiments, the processor may optimize the policy optimization objective function via gradient descent, thereby adjusting the parameters of the policy network.

In some embodiments, collective trajectory data includes: for each of the UVs and at each time step: the global state, the local observation, the action executed by the UV, the reward value received by the UV, state transition information, and the action execution probability that corresponds to the action executed by the UV and is generated by the policy network.

In some embodiments of the present disclosure, by sharing the collective trajectory data and performing collective learning, collaborative development among the UVs is promoted, thereby avoiding inefficiency and coordination issues that may arise from independent training of individual UVs. Sharing the parameters of the policy network helps reduce redundant computation and avoid inconsistency between policies, thereby improving the overall performance of the multi-UV system. By updating the collective trajectory data, the experience of the entire multi-UV system is fully utilized, ensuring that each of the UVs can learn from collective actions and continuously optimize the policy of each of the UVs during a global collaboration process. This approach significantly improves the execution efficiency and decision-making accuracy of the multiple UVs in complex tasks, thereby enhancing the robustness and adaptability of the multi-UV system.

In some embodiments of the present disclosure, by determining the state-value function, the action-value function, and the advantage function based on the critic network, a collaborative decision-making process of the multiple UVs can be effectively evaluated and optimized. By introducing the advantage function to measure the advantageous degree of each action and further optimizing the policy, adaptive adjustment based on the global state and real-time rewards in dynamic environments can be ensured, thereby improving the decision-making efficiency and accuracy of the multi-UV system. Simultaneously, by updating the policy using the gradient descent manner based on the policy optimization objective function J(θ), the performance of the entire multi-UV system can be stably enhanced, ensuring stronger adaptability and robustness when facing complex tasks and changing environments.

In 140, executing a distributed execution phase, including: obtaining, by each of the UVs, an action probability distribution function via the optimized policy network based on the policy prompt; and obtaining, by each of the UVs, the next action through sampling based on the action probability distribution function.

The distributed execution phase refers to a phase where action decision-making and action execution are completed without global coordination.

In some embodiments, in response to the completion of optimization of the parameters of the policy network, the multi-UV coordinated control system enters the distributed execution phase.

The action probability distribution function refers to a probability distribution of a candidate action set after normalization processing.

In some embodiments, the processor may obtain the action probability distribution function by performing the normalization processing on the token sequence of candidate actions through the policy network.

In some embodiments, the processor may randomly select the next action of each of the UVs based on the action probability distribution function.

For example, the processor may obtain a cumulative probability for each action based on the action probability distribution function, generate a uniformly distributed random number, and select an action whose cumulative probability first exceeds the uniformly distributed random number as the next action.

In some embodiments, the processor may determine a target action for each of the UVs by sampling based on the action probability distribution function. The processor controls the movement of each of the UVs based on the target action.

The target action refers to a next action that the UV needs to execute.

In some embodiments, the target action is one of forward, backward, left turn, right turn, stop, accelerate, and decelerate.

In some embodiments, the manner of determining the target action of each of the UVs through sampling is similar to the manner for randomly sampling an action from the executable action set. More descriptions regarding how to sampling may be found in the related descriptions of operation 130 above.

In some embodiments of the present disclosure, by constructing the policy network and the communication network based on the environment-aligned LLM, the UVs can efficiently interpret the task requirements and the environmental information, thereby generating more reasonable control policies. Compared with traditional reinforcement learning manners, utilizing the natural language understanding capability of the LLM enables policy decision-making to no longer rely solely on numerical optimization but combines high-level task descriptions for reasoning, thereby improving the flexibility, generalization capability, and environmental adaptability of the policy. Simultaneously, the communication network generates a unified global state by inferring from the local observation of each of the UVs, making individual decision-making more precise, avoiding uncertainty caused by limited information sharing, and improving the collaborative efficiency and task completion of the multi-UV system.

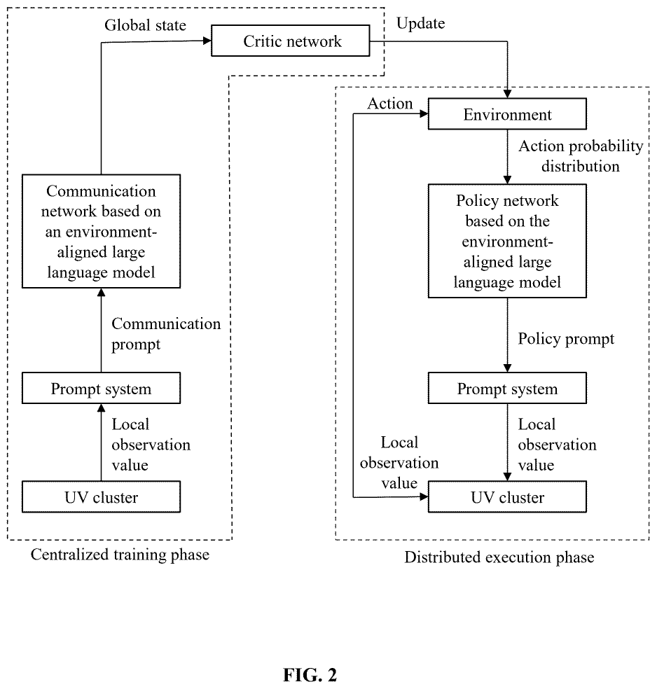

FIG. 2 is a schematic diagram illustrating an exemplary process for coordinated control of multiple UVs according to some embodiments of the present disclosure.

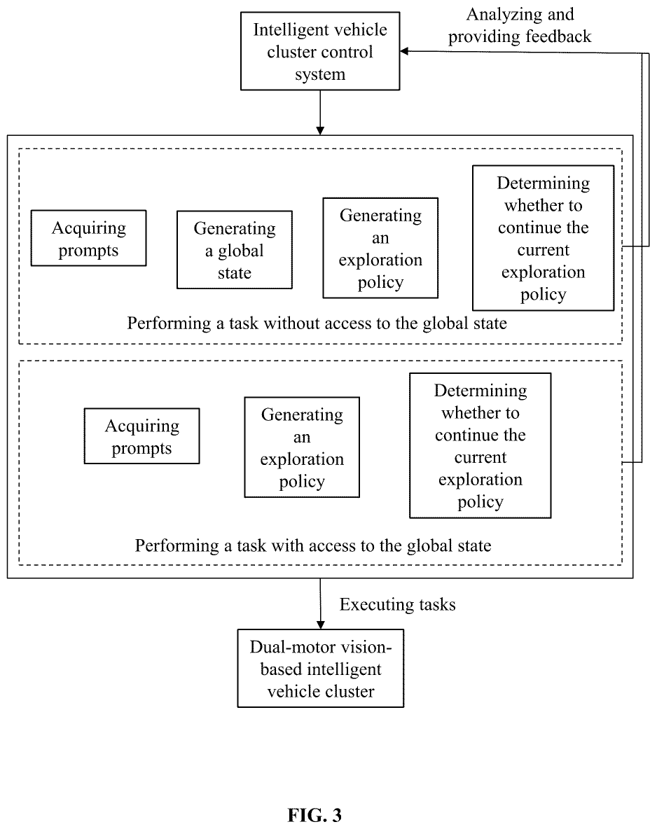

FIG. 3 is an exemplary system relationship diagram illustrating an environment-aligned LLM module and multi-agent reinforcement learning (MARL) according to some embodiments of the present disclosure.

In some embodiments, as shown in FIG. 2 and FIG. 3, a dual-motor vision intelligent vehicle is a four-wheel industrial intelligent vehicle featuring strong environmental adaptability, using front and rear dual motors and is equipped with a vision sensor. This embodiment uses the dual-motor vision intelligent vehicle as the UV, take environmental exploration as the task, and implement based on the technical solution of the present disclosure.

The environment-aligned LLM module (also referred to as a multi-agent reinforcement learning (MARL) module based on an environment-aligned LLM may distinguish two task execution scenarios for a dual-motor vision-based intelligent vehicle cluster according to different execution policies, thereby providing support for full-process logical analysis and diagnosis. The specific scenarios are as follows:

Scenario 1: When the dual-motor vision-based intelligent vehicle cluster needs to execute an environmental exploration task in which the global state is accessible.

Scenario 2: When the dual-motor vision-based intelligent vehicle cluster needs to execute an environmental exploration task in which the global state is inaccessible.

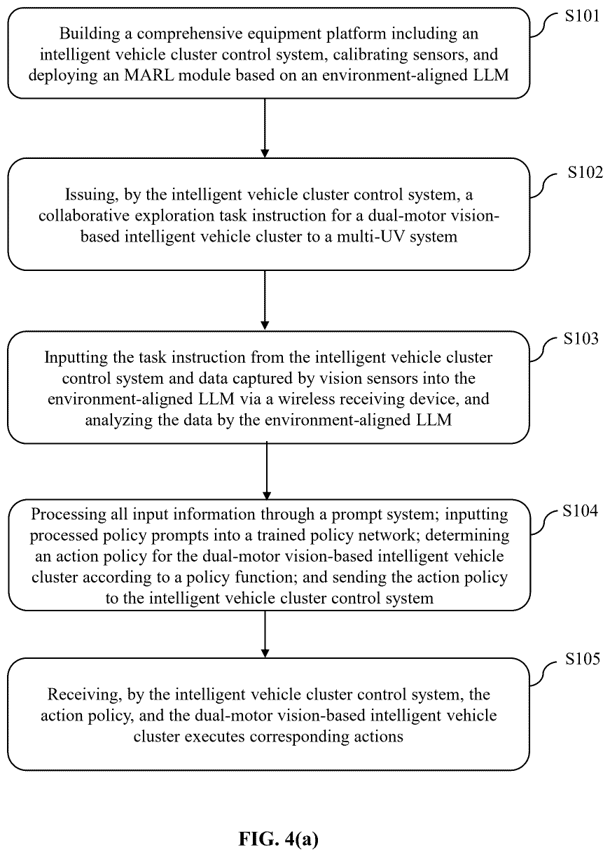

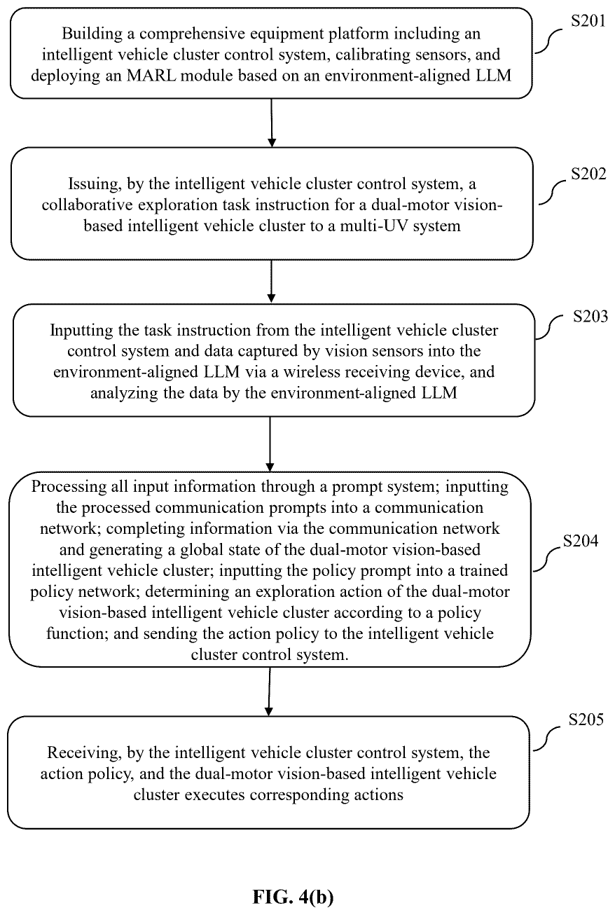

FIGS. 4(a) and 4(b) are flowcharts illustrating implementation examples of a method for coordinated control of multiple UVs based on an environment-aligned LLM according to some embodiments of the present disclosure.

FIG. 4(a) is a flowchart for a dual-motor vision-based intelligent vehicle cluster performing an environmental exploration task with access to the global state. FIG. 4(b) is a flowchart for a dual-motor vision-based intelligent vehicle cluster performing an environmental exploration task without access to the global state.

When the dual-motor vision intelligent vehicle faces Scenario 1, specific steps for executing related tasks through the environment-aligned LLM module and MARL include:

Step S101: Building a comprehensive equipment platform including an intelligent vehicle cluster control system, calibrating sensors, and deploying the MARL module based on the environment-aligned LLM.

Step S102: Issuing, by the intelligent vehicle cluster control system, a collaborative exploration task instruction for the dual-motor vision-based intelligent vehicle cluster to a multi-UV system.

Step S103: Inputting the task instruction from the intelligent vehicle cluster control system and data captured by vision sensors into the environment-aligned LLM via a wireless receiving device, and analyzing the data by the environment-aligned LLM.

Step S104: Processing all input information through a prompt system; inputting processed policy prompts into a trained policy network; determining an action policy for the dual-motor vision-based intelligent vehicle cluster according to a policy function; and sending the action policy to the intelligent vehicle cluster control system.

Step S105: Receiving, by the intelligent vehicle cluster control system, the action policy, and the dual-motor vision-based intelligent vehicle cluster executes corresponding actions. In some embodiments, the intelligent vehicle cluster control system receives the action policy from the policy network and performs evaluation and analysis. If a current action executed by the dual-motor vision-based intelligent vehicle cluster meets the requirements of the task instruction issued by the intelligent vehicle cluster control system, the dual-motor vision-based intelligent vehicle cluster is allowed to continue the current exploration by default. If the current action executed by the dual-motor vision-based intelligent vehicle cluster does not meet the requirements of the task instruction issued by the intelligent vehicle cluster control system, the intelligent vehicle cluster control system sends an instruction to stop the current action of the dual-motor vision-based intelligent vehicle cluster, and requires the system modules to re-collect all data and repeat Steps S103 to S105 until an exploration result of the dual-motor vision-based intelligent vehicle cluster meets the requirements of the task instruction issued by the intelligent vehicle cluster control system, and then the process stops.

When the dual-motor vision intelligent vehicle faces Scenario 2, specific steps for executing related tasks through the environment-aligned LLM module and MARL include:

Step S201: Building a comprehensive equipment platform including an intelligent vehicle cluster control system, calibrating sensors, and deploying the MARL module based on the environment-aligned LLM.

Step S202: Issuing, by the intelligent vehicle cluster control system, a coordinated exploration task instruction for the dual-motor vision-based intelligent vehicle cluster to the multi-UV system.

Step S203: Inputting the task instruction from the intelligent vehicle cluster control system and data captured by vision sensors into the environment-aligned LLM via a wireless receiving device, and analyzing the data by the environment-aligned LLM.

Step S204: Processing all input information through a prompt system; inputting the processed communication prompts into a communication network; completing information via the communication network and generating a global state of the dual-motor vision-based intelligent vehicle cluster; inputting the policy prompt into a trained policy network; determining an exploration action of the dual-motor vision-based intelligent vehicle cluster according to a policy function; and sending the action policy to the intelligent vehicle cluster control system.

Step S205: Receiving, by the intelligent vehicle cluster control system, the action policy, and the dual-motor vision-based intelligent vehicle cluster executes corresponding actions. In some embodiments, the intelligent vehicle cluster control system receives the action policy from the policy network and performing evaluation and analysis. If a current action executed by the dual-motor vision-based intelligent vehicle cluster meets requirements of the task instruction issued by the intelligent vehicle cluster control system, the dual-motor vision-based intelligent vehicle cluster is allowed to continue the current exploration by default. If the current action executed by the dual-motor vision-based intelligent vehicle cluster does not meet the requirements of the task instruction issued by the intelligent vehicle cluster control system, sending an instruction to stop the current exploration action of the dual-motor vision-based intelligent vehicle cluster, requiring the system module to re-collect all data, and repeating Steps S203 to S205 until an exploration result of the dual-motor vision-based intelligent vehicle cluster meets the requirement of the task instruction issued by the intelligent vehicle cluster control system, and then stopping the process.

The MARL based on the environment-aligned LLM according to the present disclosure integrates advantages of LLMs and MARL. By leveraging powerful prior knowledge and semantic understanding capabilities of the LLM, this approach provides policy initialization and a more effective exploration process for MARL. This combination reduces ineffectiveness of initial random exploration, improves sample efficiency, and accelerates training convergence.

In the MARL based on the environment-aligned LLM according to the present disclosure, the LLM serves as the communication network and infers the global state through causal reasoning, reducing reliance on complex communication mechanisms and the global state. This design improves scalability of the multi-UV system, enabling efficient decision-making even in partially observable environments.

In the MARL based on the environment-aligned LLM according to the present disclosure, compact and efficient prompts are designed for the policy network and the communication network, reducing redundant representation of the input and optimizing memory usage. The manner effectively supports expansion of the multi-UV system and ensures efficiency and adaptability of the framework.

Principles of the present disclosure are as follows:

A core principle of LLMs is to predict a probability of a next token in a sequence based on the preceding context of a given sequence. Formally, a joint probability of a token sequence (x₁, x₂, . . . , xₖ) may be decomposed as:

$${P}_{L L M s} ( {x}_{1} , {x}_{2} , … , {x}_{k} ) = {\prod }_{i = 1}^{k} P ( {x}_{i} \vert {x}_{1} , {x}_{2} , … , {x}_{i - 1} ) ,$$

wherein P_{LLMs}(xᵢ|x₁, x₂, . . . , xᵢ₋₁) represents a conditional probability of xᵢ given all prior tokens in the sequence according to the LLMs. In MARL, the policy network is defined as a mapping that generates a probability distribution P(aⁱ|oⁱ) over actions, and the communication network is defined as a mapping that generates a probability distribution P(s|o¹, . . . , oⁿ) over the global state via communication. To integrate these into the framework, the corresponding actions, local observations, and global state are converted into text representations through prompt design. A tokenizer then processes the text prompts to generate corresponding token sequences aⁱ={x₁, . . . , x_{|a}_{ⁱ}_{|}}, oⁱ={x₁, . . . , x_{|o}_{ⁱ}_{|}} and s={x₁, . . . , x_{|s|}}, where |⋅| represents a length of the token sequence. The policy network processed by the LLMs may be written as:

$${P}_{L L M s} = \frac{{P}_{L L M s} ( {a}^{i} , {o}^{i} )}{{P}_{L L M s} ( {o}^{i} )} = \frac{{\prod }_{i = 1}^{\vert {a}^{i} \vert + \vert {o}^{i} \vert} P ( {x}_{i} \vert {x}_{1} , {x}_{2} , … , {x}_{i - 1} )}{{\prod }_{j = 1}^{\vert {o}^{i} \vert} P ( {x}_{j} \vert {x}_{1} , {x}_{2} , … , {x}_{j - 1} )} = {\prod }_{i = \vert {o}^{i} \vert + 1}^{\vert {a}^{i} \vert + \vert {o}^{i} \vert} P ( {x}_{i} \vert {x}_{1} , {x}_{2} , … , {x}_{i - 1} )$$

A communication network P_{LLMs}(s|o¹, . . . , oⁿ) computed by LLMs may be expressed as an equation:

$${P}_{L L M s} ( s \vert {o}^{1} , … , {o}^{n} ) = {\prod }_{i = {\sum }_{k = 1}^{n} \vert {o}^{k} \vert + 1}^{\vert s \vert + {\sum }_{k = 1}^{n} \vert {o}^{k} \vert} P ( {x}_{i} \vert {x}_{1} , {x}_{2} , … , {x}_{i - 1} ) .$$

The left side of the equation represents a probability of generating a state sequence s given all local observations. The right side of the equation is a form of probability product, starting from an index

$$i = {\sum }_{k = 1}^{n} \vert {o}^{k} \vert + 1$$

and ending at an index

$$\vert s \vert + {\sum }_{k = 1}^{n} \vert {o}^{k} \vert .$$

Each product term P(xᵢ|x₁, x₂, . . . , xᵢ₋₁) represents a probability of generating an i-th element, conditioned on all preceding elements. The observation sequence o¹, . . . , oⁿ is concatenated into a fixed context, occupying first

$${\sum }_{k = 1}^{n} \vert {o}^{k} \vert$$

positions. The state sequence s is generated starting from a position immediately following the observations, i.e., from

$$i = {\sum }_{k = 1}^{n} \vert {o}^{k} \vert + 1 to i = {\sum }_{k = 1}^{n} \vert {o}^{k} \vert + \vert s \vert .$$

At each step of generating a state element xᵢ, the conditional history includes all observations and generated state elements. For example, if a total length of observations is 7 and a length of state elements is 5, the state sequence is generated in a range from i=8 to i=12, and the conditional history for each xᵢ is x₁, x₂, . . . , xᵢ₋₁. The equation generates the state sequence step by step in an autoregressive manner, where a probability of each step is based on complete historical information, and a final probability is a joint product of probabilities of each generation step.

Based on the above analysis, a construction manner for defining LLMs as the policy network and the communication network is established. An initial state of the policy network is not a random policy, but utilizes prior knowledge embedded in the LLMs to reduce ineffective exploration. Similarly, for the communication network, causal reasoning capabilities of the LLMs may be used to extract the global state from the local observations. This fundamental insight constitutes a motivation for building an environmental-aligned large language model (EALLM) framework.

Specifically, a current observation and available actions of the UV are first textualized to form a policy prompt. The local observation is formatted as an input, and each valid action is formatted as a response. These components are then combined with a task-specific instruction (e.g., cooperate with a team to complete a task) to form the policy prompt. The prompt is tokenized by the tokenizer and input to a policy network EALLMs-P.

Token probabilities generated by the policy network EALLMs-P are then used to calculate probabilities of corresponding actions. It should be noted that each action may consist of a different count of tokens (e.g., “stop” and “move north one step” have 1 and 4 tokens, respectively). When the probability is calculated as a product of token probabilities, an action containing more tokens results in a smaller cumulative value. To address this issue, dividing the probability by the token length ensures that probabilities of actions with different token lengths are on the same scale. Additionally, the calculated probability P_{LLMs}(aⁱ|oⁱ) is essentially the logits of each token and is not normalized. Therefore, an additional softmax operation is applied to the logits to obtain the execution probability for each executable action:

$$P ( {a}^{i} \vert {o}^{i} ) = \frac{exp ( log {P}_{L L M s} ( {a}^{i} \vert {o}^{i} ) / \vert {a}^{i} \vert )}{{\sum }_{{a}^{i} ∈ {A}^{i}} exp ( log {P}_{L L M s} ( {a}^{i} \vert {o}^{i} ) / \vert {a}^{i} \vert )} .$$

The communication response part of the communication prompt includes the textualized global state. For example, “Enemy A is located at (3,5), and the rest of the area is safe.” The communication response part provides explicit textual descriptions of the global state, which can guide the LLMs to learn how to correctly infer global information from the local observations and ensure format consistency of the generated global state.

In the centralized training phase, an action strategy for the UV cluster is obtained through the policy network EALLMs-P. Based on the communication prompt, the global state is obtained through the policy network EALLMs-C. Based on the global state, the state-value function is obtained through the critic network. Based on the state-value function, the decision quality of the policy network EALLMs-P is evaluated. Based on the evaluation result, parameters of the policy network EALLMs-P are optimized. This process is achieved by using the following equations:

$${V}_{π} ( s ) = 𝔼 [ {\sum }_{t = 0}^{∞} {γ}^{t} {r}_{t + 1} \vert {s}_{0} = s ] ,$$

wherein V_{π}(s) represents the expected cumulative reward obtained given the global state s where γ is a discount factor, π represents a joint policy,

$$π = {\prod }_{i = 1}^{n} {π}^{i} ,$$

and s₀ is the global state at time step t=0;

$${Q}_{π} ( s , a ) = 𝔼 [ {\sum }_{t = 0}^{∞} {γ}^{t} {r}_{t + 1} \vert {s}_{0} = s , {a}_{0} = a ] ,$$

wherein Q_{π}(s, a) represents the expected cumulative reward obtained given the global state s and the executed action a. a₀ denotes the action taken at time step t=0. The distinction from the state-value function is that the action-value function Q_{π}(s, a) includes an initial action, whereas the initial action of V_{π}(s) is determined by the policy;

$${A}_{π} ( s , a ) = {Q}_{π} ( s , a ) - {V}_{π} ( s ) ,$$

wherein A_{π}(s, a) represents a difference between the expected reward obtained by executing the action a under the same joint policy π and the global state s, and the average performance of the policy. The advantage function measures the relative advantage of disadvantage of executing the action a in the state s compared to the average performance of the joint policy π. If A_{π}(s, a)>0, a return of the action a is higher than an average return of the joint policy π in the state s, indicating that the action is better:

$$J ( θ ) = {\sum }_{i = 1}^{n} {E}_{s , a} [ min ( \frac{{π}_{θ} ( {a}^{i} \vert {o}^{i} )}{{π}_{{θ}_{k}} ( {a}^{i} \vert {o}^{i} )} {A}_{{π}_{{θ}_{k}}} ( s , a ) , clip ( \frac{{π}_{θ} ( {a}^{i} \vert {o}^{i} )}{{π}_{{θ}_{k}} ( {a}^{i} \vert {o}^{i} )} , 1 \pm ϵ ) {A}_{{π}_{{θ}_{k}}} ( s , a ) ) ]$$

wherein π_{θ}(aⁱ|oⁱ) represents a current policy, π_{θ}_{ₖ}(aⁱ|oⁱ) represents a policy from a previous iteration step, and a ratio between the two is the importance sampling ratio, representing the probability ratio of selecting the action under a new policy π_{θ} versus an old policy π_{θ}_{ₖ}. The advantage function

$${A}_{{π}_{{θ}_{k}}} ( s , a )$$

measures the relative advantage of executing the action a in the state s compared to the average performance of the old policy π_{θ}_{ₖ}. The clip operation restricts the importance sampling ratio within the range of [1−ϵ, 1+ϵ] to prevent excessive policy updates. ϵ is a hyperparameter defining the clipping range for the importance sampling ratio. The min function takes the smaller of the two values, ensuring that policy updates neither deviate too far from the old policy nor fail to leverage positive signals from the advantage function.

If the aforementioned functions are implemented in the form of software functional units and sold or used as independent products, they may be stored in a non-transitory computer-readable storage medium. Based on this understanding, the technical solution of the present disclosure, in essence, or the part contributing to the prior art, or part of the technical solution, can be embodied in the form of a software product. The computer software product is stored in a storage medium and includes instructions for causing a computer device (e.g., a personal computer, a server, or a network device, etc.) to perform all or part of the steps and operations of the methods described in the various embodiments of the present disclosure. The aforementioned storage medium includes: a U disk, a mobile hard disk, a read-only memory (ROM), a random access memory (RAM), a magnetic disk, an optical disk, or any other medium that can store program code.

The foregoing descriptions are merely specific implementations of the present disclosure. However, the protection scope of the present disclosure is not limited thereto. Any person skilled in the art can easily conceive of various equivalent modifications or substitutions within the technical scope disclosed in the present disclosure. These modifications or substitutions shall fall within the protection scope of the present disclosure. Therefore, the protection scope of the present disclosure shall be subject to the protection scope of the claims.

What is claimed is:

1. A method for coordinated control of multiple unmanned vehicles (UVs) based on an environment-aligned large language model (LLM), comprising:
obtaining, by each of the UVs, a local observation from an environment;
transmitting, by each of the UVs, the local observation to a prompt system, and obtaining, based on the local observation, a policy prompt and a communication prompt for each of the UVs via the prompt system;
executing a centralized training phase, including:
obtaining, based on the communication prompt, a global state via a communication network;
generating, for each of the UVs, an executable action sequence and an action execution probability of each executable action in the executable action sequence based on the policy prompt via a policy network;
obtaining, for each of the UVs, a next action through sampling based on the action execution probability, executing the next action, and obtaining a reward value; and
inputting the global state and the reward value into a critic network, and optimizing parameters of the policy network shared by all of the UVs via the critic network;
executing a distributed execution phase, including:
obtaining, for each of the UVs, an action probability distribution function via the optimized policy network based on the policy prompt; and
obtaining, for each of the UVs, the next action through sampling based on the action probability distribution function.

2. The method of claim 1, wherein the environment-aligned LLM includes the policy network based on the environment-aligned LLM, the communication network based on the environment-aligned LLM, the prompt system, and the critic network based on a multilayer perceptron; the policy network and the communication network are both pre-trained LLMs.

3. The method of claim 1, wherein the local observation is a partial information set perceived by a single UV from the environment at a current time, and the partial information set includes position information, velocity information, path planning information, sensor information, and environmental state information.

4. The method of claim 1, wherein an acquisition process for the policy prompt includes:
the prompt system receiving the local observation transmitted by each of the UVs, performing a formatting processing on the local observation of each of the UVs, converting the local observation of each of the UVs into structured text, and for each of the UVs, combining the structured text for the UV with a preset task instruction to form the policy prompt for the UV, the policy prompt including a policy instruction part, a policy input part, and a policy response part, wherein:
the policy instruction part is used for describing a task objective and defining a decision-making purpose of each of the UVs, including navigation, obstacle avoidance, and collaborative task execution, and a textual description corresponding to a current task instruction for each of the UVs is extracted from a preset task library based on the preset task instruction for each of the UVs;
the policy input part is textualized local observations of all of the UVs, including states of all of the UVs, perceived environmental information, and key information capable of affecting decisions of other UVs, described in the form of structured text;
the policy response part is a formatted executable action set, all legal actions are extracted under current local observation conditions for each of the UVs from a predefined action library and the legal actions are converted into a textual form, wherein the executable action set includes forward, backward, left turn, right turn, stop, accelerate, and decelerate.

5. The method of claim 1, wherein an acquisition process for the communication prompt includes:
the prompt system receiving the local observation transmitted by each of the UVs, performing formatting processing on the local observation of each of the UVs, converting the local observation into a textual description, and for each of the UVs, combining the textual description for the UV with a preset communication instruction to generate the communication prompt for the UV, the communication prompt including a communication instruction part, a communication input part, and a communication response part, wherein:
the communication instruction part is used for describing a communication objective and defining an information interaction goal among the UVs, including sharing environmental information, exchanging state data, and supporting collaborative decision-making, and for extracting a corresponding textual description from a preset communication instruction library based on the preset communication instruction;
the communication input part is textualized local observations of all of the UVs, including states of all of the UVs, perceived environmental information, and key information capable of affecting decisions of other UVs, described in a form of structured text;
the communication response part is a textualized global state from a previous time step, based on the local observations of all of the UVs at the previous time step, the global state being inferred by the communication network based on the environment-aligned LLM and converted into a textual representation.

6. The method of claim 1, wherein the obtaining, based on the communication prompt, a global state via a communication network, includes:
processing the communication prompt through a tokenizer to obtain a corresponding token sequence;
inputting the token sequence into the communication network; and
generating, by the communication network, a textualized global state for a current time step based on the communication objective in the communication prompt, the local observation of each of the UVs, and a textualized global state from a previous time step.

7. The method of claim 1, wherein the generating, by each of the UVs, an executable action sequence and an action execution probability of each executable action in the executable action sequence based on the policy prompt via a policy network, includes:
processing the policy prompt through a tokenizer to generate a policy prompt token sequence, and providing the policy prompt token sequence as an input to the policy network based on the environment-aligned LLM;
generating, by the policy network based on the policy prompt token sequence, an executable action token sequence and a generation probability corresponding to the executable action token sequence, using an equation:
$$P ( {a}_{i} \vert o ) = \frac{{\prod }_{i = 1}^{{T}_{{a}_{i}}} P ( {x}_{i} \vert {x}_{1} {x}_{2} , … , {x}_{i - 1} )}{{\prod }_{i = 1}^{{T}_{o}} P ( {x}_{j} \vert {x}_{1} {x}_{2} , … , {x}_{j - 1} )}$$
wherein P(aⁱ|o) represents a generation probability of generating an action sequence aᵢ given the local observations o of all of the UVs, Tₐ_{ᵢ} denotes a token count of the action sequence aᵢ, Tₒ denotes a token count of a local observation sequence o of all of the UVs, and P(xᵢ|x₁, x₂, . . . , xᵢ₋₁) represents a probability of generating a current token xᵢ given preceding i−₁ tokens, and wherein an executable action includes one or more tokens;
performing softmax normalization processing on the executable action token sequence to obtain the action execution probability of each executable action in the executable action sequence, using an equation:
$${P}_{softmax} ( {a}_{i} \vert o ) = \frac{exp ( log P ( {a}_{i} \vert o ) / \vert {a}_{i} \vert )}{{\sum }_{{a}_{i} ∈ A} exp ( log P ( {a}_{i} \vert o ) / \vert {a}_{i} \vert )}$$
wherein P_{softmax}(aᵢ|o) represents an action execution probability of an action aᵢ given the local observations o of all of the UVs, |aᵢ| denotes a token count in the executable action aᵢ, and A represents an executable action set containing all executable actions.

8. The method of claim 1, wherein the obtaining, by each of the UVs, a next action through sampling based on the action execution probability, includes:
selecting, based on the action execution probability generated for each of the UVs, an action from an executable action set using a stochastic sampling technique, wherein the stochastic sampling technique includes:
performing a weighted random selection based on the execution probability of each action in the executable action set,
designating the execution probability of each action in the executable action set as a weight of selection for the each action, and
randomly selecting an action from the executable action set.

9. The method of claim 1, wherein the inputting the global state and the reward value into a critic network, and optimizing parameters of the policy network shared by all of the UVs via the critic network, includes:
inputting a global state Sₜ at a current time step and a corresponding reward value rₜ₊₁ into the critic network;
determining, by the critic network, a state-value function V_{π}(Sₜ) based on the global state Sₜ at the current time step, using an equation:
$${V}_{π} ( {S}_{t} ) = 𝔼 [ {\sum }_{t = 0}^{∞} {γ}^{t} {r}_{t + 1} \vert {s}_{0} = {S}_{t} ]$$
wherein γ denotes a discount factor, π represents a joint policy
$$π = {\prod }_{i = 1}^{n} {π}^{i} ,$$
πⁱ denotes a policy of a UV i, s₀ denotes a global state at an initial time step, and V_{π}(Sₜ) represents an expected cumulative reward obtainable from the global state Sₜ under a policy π obtained from a current policy network;
determining, by the critic network, an action-value function Q_{π}(Sₜ, aₜ) based on the global state and an action aₜ executed at the current time step, using an equation:
$${Q}_{π} ( {S}_{t} , {a}_{t} ) = 𝔼 [ {\sum }_{t = 0}^{∞} {γ}^{t} {r}_{t + 1} \vert {s}_{0} = {S}_{t} , {a}_{0} = {a}_{t} ]$$
wherein a₀ denotes an action taken at the initial time step, and Q_{π}(Sₜ, aₜ) represents an expected cumulative reward obtainable after taking the action aₜ in the global state Sₜ under the policy π obtained from the current policy network;
determining an advantage function A_{π}(Sₜ, aₜ) based on the state-value function V_{π}(Sₜ) and the action-value function Q_{π}(Sₜ, aₜ), using an equation:
$${A}_{π} ( {S}_{t} , {a}_{t} ) = {Q}_{π} ( {S}_{t} , {a}_{t} ) - {V}_{π} ( {S}_{t} )$$
wherein A_{π}(Sₜ, aₜ) represents a measure of an advantageous degree of taking the action aₜ in the global state Sₜ, relative to an average performance of the policy π;
determining a policy optimization objective function J(θ) based on the advantage function A_{π}(Sₜ, aₜ), using an equation:
$$J ( θ ) = {\sum }_{i = 1}^{n} {E}_{s , a} [ min ( \frac{{π}_{θ} ( {a}^{i} \vert {o}^{i} )}{{π}_{{θ}_{k}} ( {a}^{i} \vert {o}^{i} )} {A}_{{π}_{{θ}_{k}}} ( s , a ) , clip ( \frac{{π}_{θ} ( {a}^{i} \vert {o}^{i} )}{{π}_{{θ}_{k}} ( {a}^{i} \vert {o}^{i} )} , 1 \pm ϵ ) {A}_{{π}_{{θ}_{k}}} ( s , a ) ) ]$$
wherein π_{θ}(aⁱ|oⁱ) represents an action probability of the current policy network, π_{θ}_{ₖ}(aⁱ|oⁱ) represents a policy from a previous iteration step, a ratio of π_{θ}(aⁱ|oⁱ) to
$${π}_{{θ}_{k}} ( {a}^{i} \vert {o}^{i} ) \frac{{π}_{θ} ( {a}^{i} \vert {o}^{i} )}{{π}_{{θ}_{k}} ( {a}^{i} \vert {o}^{i} )}$$
represents an importance sampling ratio measuring a change in action selection between a new policy and an old policy,
$${A}_{{π}_{{θ}_{k}}} ( s , a )$$
represents an advantage function of the policy from the previous iteration step, a clip operation constrains the importance sampling ratio within a range [1−ϵ, 1+ϵ], ϵ denotes a hyperparameter defining a maximum change range for a policy update; and
optimizing the policy optimization objective function J(θ) via gradient descent to adjust the parameters of the policy network.

10. The method of claim 1, wherein all of the UVs share a set of parameters of the policy network, and the set of parameters of the policy network is updated based on collective trajectory data, wherein the collective trajectory data includes: for each of the UVs and at each time step: the global state, the local observation, the action executed by the UV, the reward value received by the UV, state transition information, and the action execution probability that corresponds to the action executed by the UV and is generated by the policy network.
